(19) United States
(12) Patent Application Publication
(10) Pub. No.: US 2010/0033559 A1
(43) Pub. Date: Feb. 11, 2010

(54) IMAGE PICK-UP MODULE FOR ENDOSCOPE APPARATUS

(75) Inventor: Shinji YASUNAGA, Asaka-shi (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/536,116

(22) Filed: Aug. 5, 2009

(30) Foreign Application Priority Data
Aug. 5, 2008 (JP) 2008-202094

(51) Int. Cl. H04N 7/18

(52) U.S. Cl. 348/65; 348/E07.085

(57) ABSTRACT

An image pick-up module for an endoscope apparatus includes a base having a surface on which electronic elements including an image pick-up device, and an electronic cooling element are mounted. The surface of the base is provided with terminals for the electronic elements including the image pick-up device, terminals for the electronic cooling element, and terminals for wirings from an outside of the image pick-up module. The base further includes wirings electrically connecting with the terminals for the electronic elements including the image pick-up device, the terminals for the electronic cooling element, and the terminals for the outside wirings.

### CROSS-REFERENCE TO RELATED APPLICATIONS

This application is based upon and claims the benefit of priority from prior Japanese Patent Application No. 2008-202094, filed Aug. 5, 2008, the entire contents of which are incorporated herein by reference.

### BACKGROUND OF THE INVENTION

1. Field of the Invention

The present invention relates to an image pick-up module for an endoscope apparatus, which is accommodated in an insertion part of the endoscope apparatus and which picks up an image of an observation target.

2. Description of the Related Art

With a progress in a technical field of semiconductor, a frame rate is improved and the number of pixels is increased in an image pick-up device used in an image pick-up module for an endoscope apparatus. As a result, the endoscope apparatus using the image pick-up module as described above realizes observation of an affected area with a high quality image.

In contrast, improvement of the performance of the image pick-up device causes a problem as described below. That is, heat, which is generated from the image pick-up device and various electronic elements used in the image pick-up module, is increased, and acts as thermal noise that prevents improvement of the quality of an image picked up by the image pick-up device.

Since the image pick-up module for the endoscope apparatus described above must be accommodated in an insertion part of the endoscope apparatus, its diameter must be reduced. Thus, heat is liable to be accumulated in the module. Accordingly, it has been desired to realize an image pick-up device cooling mechanism which can be mounted on the image pick-up module for an endoscope apparatus and which can effectively eliminate heat generated by the image pick-up module (that is, which can effectively cool the image pick-up module).

In order to cool the image pick-up device of the image pick-up module for an endoscope apparatus, Japanese Patent Application KOKAI Publication No. 2003-334156 discloses to dispose a Peltier cooling element adjacent to the image pick-up device. However, in the actual image pickup unit for an actual endoscope apparatus, various electronic elements for operating the image pick-up device (for example, passive parts including a driver chip, a capacitor, and the like) are disposed closely to the image pick-up device. In general, these electronic parts are mounted on a base and connected to many external wirings through internal wirings of the base. Japanese Patent Application KOKAI Publication No. 2007-29431 discloses that various electronic elements disposed on a base are connected to many external wirings through internal wirings of the base.

When a Peltier element is mounted on a base adjacent to an image pick-up device in the above described general configuration of the image pick-up module for an endoscope apparatus, it is necessary to bond a heat absorption surface of the Peltier element to a predetermined part of the base and to take out lead wires for controlling the Peltier element from terminals of the Peltier element. The conventional cooling mechanism for the image pick-up module for an endoscope apparatus complicates the configuration and manufacturing steps of the image pick-up module and inhibits a reduction in a diameter of the image pick-up module for an endoscope apparatus.

### BRIEF SUMMARY OF THE INVENTION

According to an aspect of the present invention, an image pick-up module for an endoscope apparatus, which is accommodated in an insertion part of the endoscope apparatus to pick up an image of an observation target, comprises: electronic elements including an image pick-up device; an electronic cooling element which includes a heat absorption surface, a heat radiation surface, and a plurality of terminals disposed on the heat absorption surface; and a base having a surface on which the electronic elements including the image pick-up device and the electronic cooling element are mounted The surface of the base is provided with a plurality of terminals for electrically connecting with the electronic elements including the image pick-up device, a plurality of terminals for electrically connecting with the plurality of terminals of the electronic cooling element, and a plurality of terminals for electrically connecting with a plurality of wirings from an outside of the image pick-up module. And, the base has wirings which electrically connect with the terminals for the electronic elements including the image pick-up device, the terminals for the electronic cooling element, and the terminals for the outside wirings.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view schematically showing an image pick-up module for an endoscope apparatus according to an embodiment of the present invention;

FIG. 2 is a perspective view schematically showing the image pick-up module of FIG. 1 from an angle different from that of the case of FIG. 1;

FIG. 3 is a perspective view schematically showing a base of the image pick-up module of FIG. 1 from the same angle as that of the case of FIG. 1;

FIG. 4 is a perspective view schematically showing the base of the image pick-up module of FIG. 2 from the same angle as that of the case of FIG. 2;

FIG. 5 is a perspective view schematically showing a modification of the image pick-up module of FIG. 1;

FIG. 6 is a schematic perspective view of a refrigerant jacket used for cooling an electronic cooling element of the image pick-up module of the modification of FIG. 5;

FIG. 7 is a schematic side elevational view of the electronic cooling element used in the image pick-up module of each of FIGS. 1 and 5;

FIG. 8 is a schematic perspective view of the electronic cooling element of FIG. 7 when viewed from its heat absorption surface; and

FIG. 9 is a side elevational view schematically showing an image pick-up module for an endoscope apparatus according to another embodiment of the present invention.

### DETAILED DESCRIPTION OF THE INVENTION

### One Embodiment and Modification

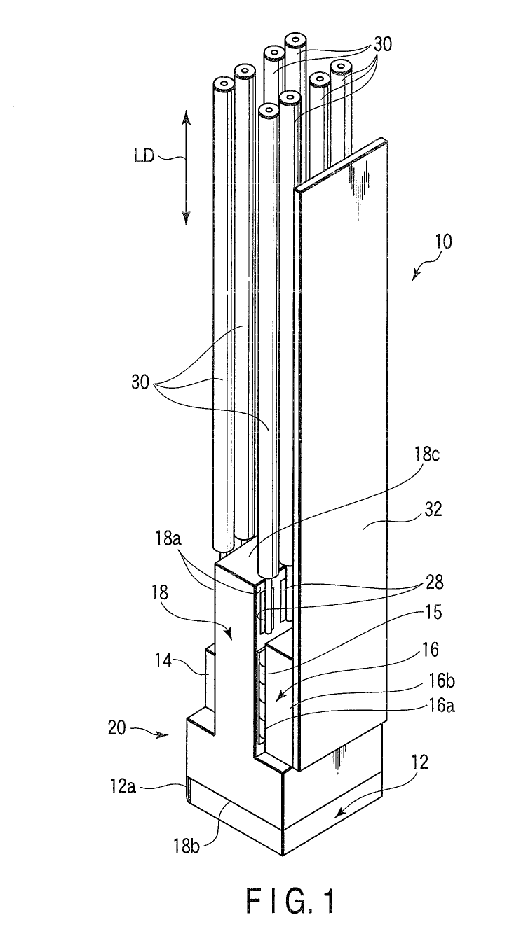

An image pick-up module 10 for an endoscope apparatus according to an embodiment of the present invention and its modification will be described with reference to FIGS. 1 to 8. The image pick-up module 10 is accommodated in a slender insertion part of a not shown endoscope apparatus and used to pick up an image of an observation target.

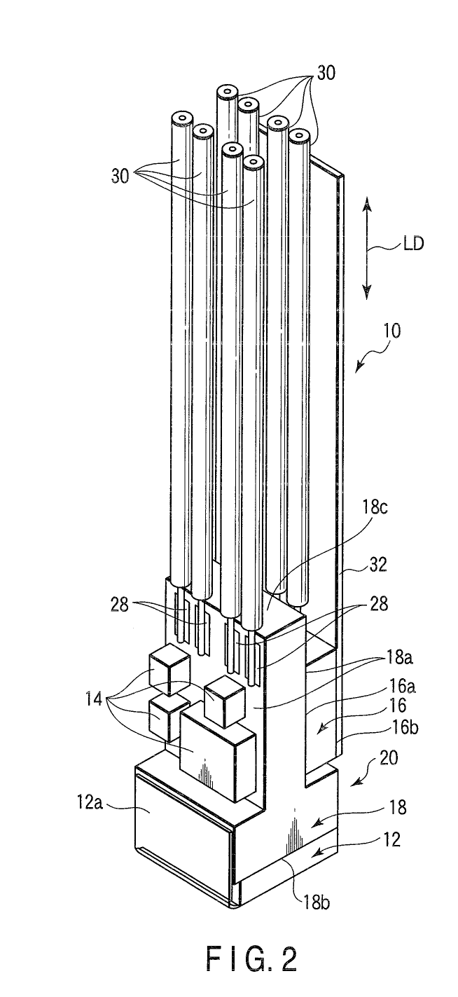

As shown in FIGS. 1 and 2, the image pick-up module 10 comprises various electronic elements including an image pick-up device 12 (in FIGS. 1 and 2, each of the electronic elements other than the image pick-up device 12 is denoted by reference numeral 14), an electronic cooling element 16 having a plurality of terminals 15 on its heat absorption surface 16a, and a base 20 including a non-conductive main body 18 on an outer surface of which the various electronic electrodes 14 including the image pick-up device 12 and the electronic cooling element 16 are mounted.

To explain in detail, the main body 18 of the base 20 has a longitudinal direction extending surface 18a extending in a longitudinal direction LD of the insertion part of the not shown endoscope apparatus, a first end 18b positioned in a distal end of the not shown insertion part, and a second end 18C directed to a proximal end of the not shown insertion part. Here, the longitudinal direction extending surface 18a of the main body 18 of the base 20 includes all of surface regions extending in the longitudinal direction LD described above on the outer surface of the main body 18. Further, the first end 18b extends in a direction orthogonal to the longitudinal direction LD described above.

In this embodiment, the image pick-up device 12 is preferably a solid-state image pick-up device, and further the electronic cooling element 16 is a so-called Peltier element.

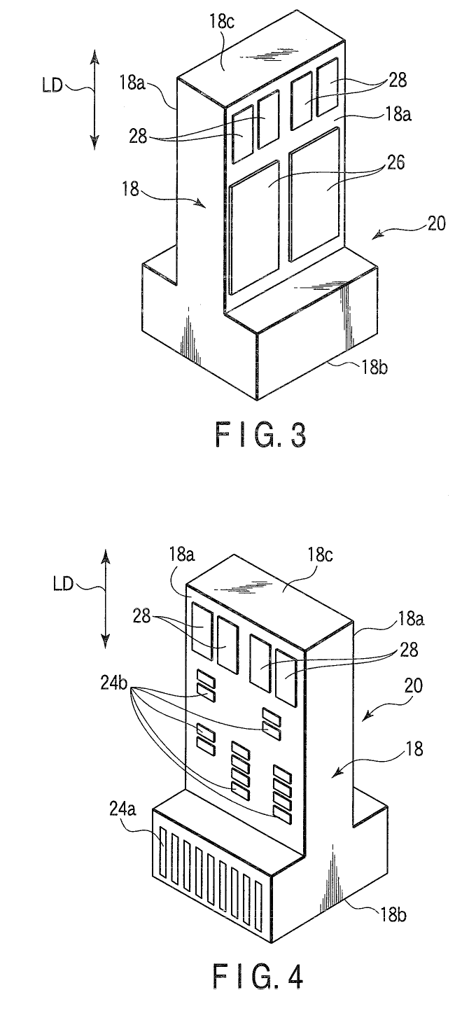

As shown in FIGS. 3 and 4, the base 20 further includes a plurality of terminals 24a, 24b which are disposed on the longitudinal direction extending surface 18a of the main body 18 and to which the image pick-up device 12 and the various electronic elements 14 are electrically connected.

The base 20 further includes a plurality of terminals 26 which are disposed on the longitudinal direction extending surface 18a of the main body 18 and to which the terminals 15 of the electronic cooling element 16 are electrically connected, and a plurality of terminals 28 which are disposed on positions closer to the second end 18c than the plurality of terminals 24a, 24b and the plurality of terminals 26 on the longitudinal direction extending surface 18a.

The base 20 further includes wirings which are connected to the plurality of terminals 24a, 24b for the electronic elements 14 including the image pick-up device 12, the plurality of terminals 26 for the electronic cooling element 16, and a plurality of external connecting terminals 28. In this embodiment, the wirings are configured by not shown internal wirings which are disposed in the main body 18.

In this embodiment, the various electronic elements 14 are various peripheral circuit chips which configure a so-called image pick-up element peripheral circuit for controlling the operation of the image pick-up device 12.

As apparent from FIGS. 1 to 4, the main body 18 of the base 20 of this embodiment has a second end side portion and a first end side portion. The second end side portion is positioned from the second end 18c to a position near to the first end 18b and has a rectangular shape which is slender in the longitudinal direction LD. The first end portion is positioned from the near position to the first end 18b and has a shape which is enlarged more than the second end side portion in a direction crossing the longitudinal direction LD. As a result, the main body 18 of the base 20 has a generally inverted T-shape in its longitudinal section along the longitudinal direction LD.

The first end 18b of the enlarged first end portion of the main body 18 is orthogonal to the longitudinal direction of the rectangular-shaped second end portion, and the image pick-up device 12 is fixed on the first end 18b by a known fixing means, for example an adhesive.

The longitudinal direction extending surface 18a of the main body 18 of the base 20 includes two regions which are in parallel with each other on the rectangular-shaped second end portion, and the two regions face in opposite radial directions of the slender insertion part of the not shown endoscope apparatus (the radial directions being orthogonal to the longitudinal direction LD). The terminals 24 for the various electronic elements 14 are disposed on one of the two regions, and the terminals 26 for the electronic cooling element 16 are disposed on the other of the two regions. Further, the terminals 28 for the external wirings 28 are disposed on the two regions so that they have the positional relation ship described above with respect to the terminals 24a for the electronic elements 30 and to the terminals 26 for the electronic cooling elements 16.

The various electronic elements 14 are electrically connected to the plurality of terminals 24b. The plurality of terminals 15 of the electronic cooling element 16 are electrically, thermally and mechanically connected to the plurality of terminals 26 by a flip-flop connection using a joint member having electric conductivity and a good thermal conductivity, for example, a metal bump such as a gold bump. A plurality of metal bumps is formed on at least one of the plurality of terminals 26 on the main body 18 of the base 20 and the plurality of terminals 15 on the electronic cooling element 16. Note that the various electronic elements 14 may be preferably mounted on the plurality of terminals 24b by using metal bumps likewise the electronic cooling element 16.

In the main body 18 of the base 20, the plurality of terminals 24a for the image pick-up device 12 are disposed on the outer periphery of the enlarged first end portion (the outer periphery being included in the longitudinal direction extending surface 18a of the main body 18 of the base 20) so that they are adjacent to the one region, on which the terminals 24b for the electronic elements 14 are disposed, of the longitudinal direction extending surface 18a on the rectangular-shaped second end side portion. A plurality of terminals of the image pick-up device 12 is electrically connected to the terminals 24a by an image pick-up device wiring 12a.

The image pick-up device wiring 12a extends from the terminals of the image pick-up device 12 to the terminals 24a of the main body 18 of the base 20 along the longitudinal direction extending surface 18a of the main body 18 of the base 20 (along the outer periphery of the enlarged first end portion included in the longitudinal direction extending surface 18a) in the longitudinal direction LD of the slender insertion part of the not shown endoscope apparatus. Such an image pick-up device wiring 12a as described above reduces the amount of projection of the image pick-up device wiring 12a from the longitudinal direction extending surface 18a of the main body 18 of the base 20 in a direction intersecting the longitudinal direction LD, as much as possible. In this embodiment, the image pick-up device wiring 12a is a flexible wiring board.

Distal end portions of the external wirings 30, which are, for example, sealed wires, for controlling the image pick-up device 12, the various electronic electrodes 14, and the electronic cooling element 16, from the outside of the slender insertion part of the not shown endoscope apparatus described above, are electrically connected to the plurality of external connecting terminals 28 on the two regions of the longitudinal direction extending surface 18a of the main body 18 of the base 20 by a known electric connecting means, for example, a solder. The plurality of external wirings 30 has flexibility and extends in the slender insertion part of the not shown endoscope apparatus in the longitudinal direction LD of the insertion part.

In this embodiment, the electronic cooling element 16 is the Peltier element. The Peltier element transfers heat absorbed by its heat absorption surface to its heat radiation surface. The electronic cooling element 16 has a heat radiation surface 16b disposed on a side opposite to the heat absorption surface 16a, and one end portion of a slender heat radiation sheet 32 is attached to the heat radiation surface 16b so that the heat is transferred from the heat radiation surface 16b to the one end portion of the slender heat radiation sheet 32. In this embodiment, the one end portion of the heat radiation sheet 32 is connected to the heat radiation surface 16b by the known heat transfer connection means. The heat radiation sheet 32 extends from the heat radiation surface 16b of the electronic cooling element 16 toward the proximal end of the insertion part of the not shown endoscope apparatus in the longitudinal direction LD of the insertion part, transfers the heat from the heat radiation surface 16b of the electronic cooling element 16 toward the proximal end of the insertion part of the not shown endoscope apparatus, and radiates the heat. Since the heat radiation sheet 32 has a good thermal conductivity and flexibility as, for example, a graphite sheet, and can be disposed even in a narrow space of the slender insertion part of the not shown endoscope apparatus so that the heat radiation sheet 32 together with the slender insertion part can be flexed freely, the heat radiation sheet 32 can effectively radiate (transfer) the heat from the heat radiation surface 16b of the electronic cooling element 16.

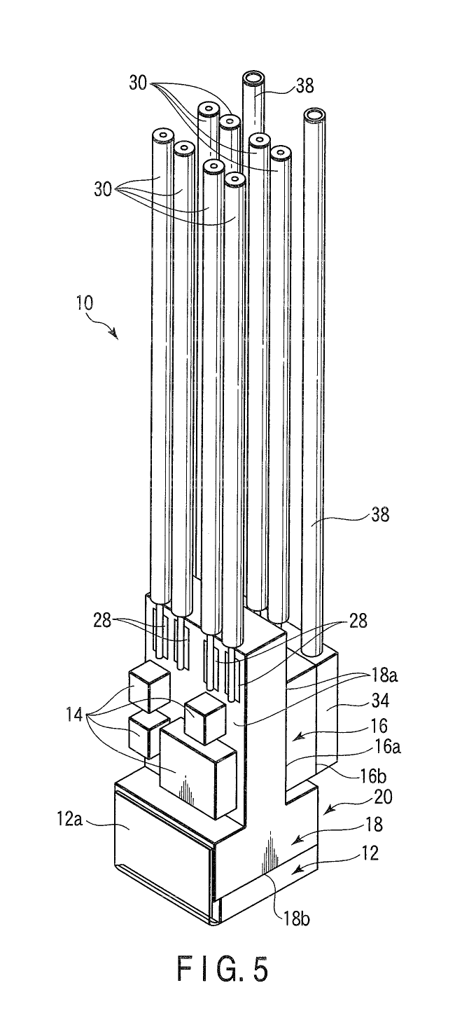

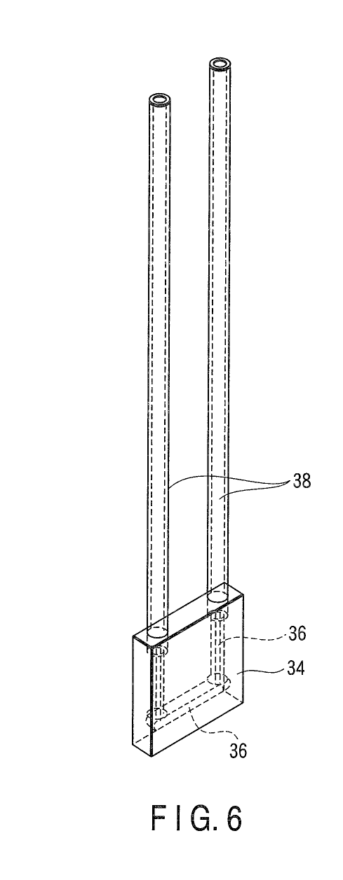

FIG. 5 shows a modification of the image pick-up module 10 of this embodiment. In this modification, a refrigerant jacket 34, in place of the heat radiation sheet 32, is attached on the heat radiation surface 16b of the electronic cooling element 16 in place of the heat radiation sheet 32 so that the refrigerant jacket 34 can transfer the heat from the heat radiation surface 16b. In this modification, the refrigerant jacket 34 is connected to the radiation surface 16b by the known heat transfer connection means. As shown in FIG. 6, the refrigerant jacket 34 has a flow path 36 which is disposed to circulate a refrigerant in the refrigerant jacket 34, and refrigerant circulation tubes 38 which extend in the longitudinal direction LD from openings of the flow path 36 of the refrigerant jacket 34 toward the proximal end of the insertion part of the not shown endoscope apparatus. By using the refrigerant jacket 34 in place of the radiation sheet 32, the heat can be more effectively radiated (transferred) from the heat radiation surface 16b of the electronic cooling element 16. The refrigerant circulation tubes 38 preferably have flexibility so that refrigerant circulation tubes 38 can be easily disposed in the narrow space of the slender insertion part of the not shown endoscope apparatus and can flex together with the slender insertion part. The refrigerant, which circulates in the refrigerant circulation tubes 38 and flow path 36 of the refrigerant jacket 34, may be any type of refrigerant which can execute a desired heat radiation (heat transfer) from the heat radiation surface 16b of the electronic cooling element 16, and the refrigerant may includes water.

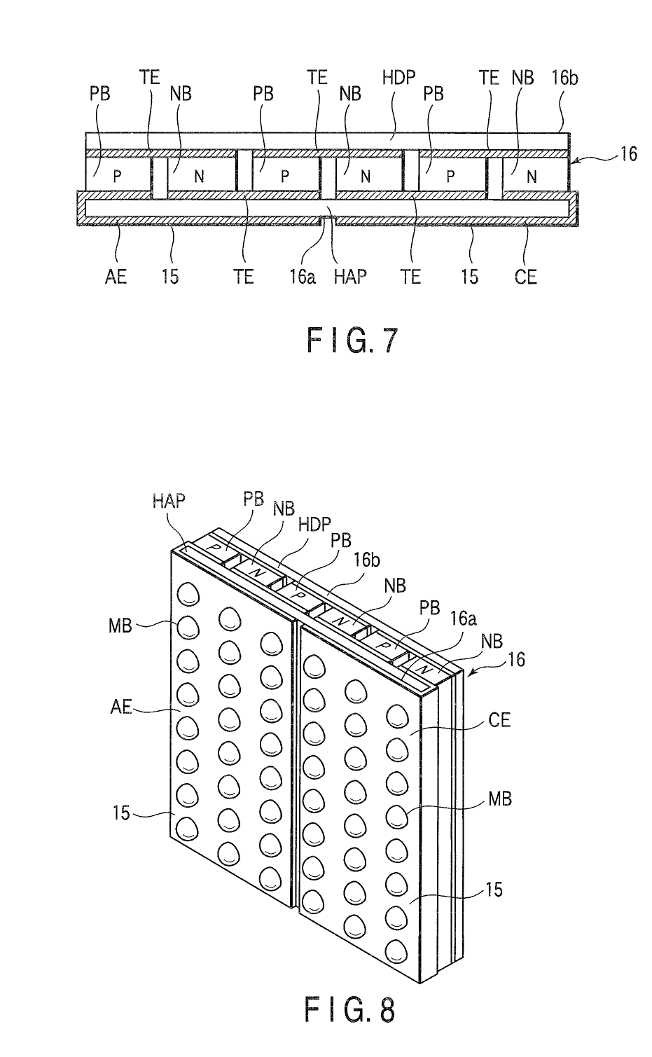

Next, with reference to FIGS. 7 and 8, a structure of the electronic cooling element 16 used in each of the image pick-up module 10 of the embodiment and that of the modification described above will be described in more detail. This electronic cooling element 16 is the so-called Peltier element and has a heat absorption plate HAP having a good heat conductivity and including the heat absorption surface 16a, a heat radiation plate HDP having a good heat conductivity and including the heat radiation surface 16b, and a plurality of P-type semiconductor blocks PB and a plurality of N-type semiconductor blocks NB, these semiconductor blocks PB and NB being disposed alternately between the heat absorption plate HAP and the heat radiation plate HDP.

The P-type semiconductor blocks PB and the N-type semiconductor blocks NB are electrically connected with each other in series between the heat absorption plate HAP and the heat radiation plate HDP by a plurality of metal thin film connectors TE formed on inner surfaces of the heat absorption plate HAP and heat radiation plate HDP. An anode terminal AE and a cathode terminal CE, both of which extend from the inner surface of the heat absorption plate HAP up to the outer surface of the heat absorption plate HAP through both of the side ends of the heat absorption plate HAP, are connected to the P-type semiconductor block PB and the N-type semiconductor block NB, both of which are positioned at the both side ends in the plurality of P-type semiconductor blocks PB and N-type semiconductor blocks NB electrically connected in series as described above. The anode terminal AE and the cathode terminal CE are formed of the metal thin film and act as the heat absorption surface 16a of the electronic cooling element 16 on the outer surface of the heat absorption plate HAP.

The anode terminal AE and the cathode terminal CE for the plurality of P-type semiconductor blocks PB and N-type semiconductor blocks NB can be also formed as described below. That is, the anode terminal AE and the cathode terminal CE are formed independently from each other on the inner surface of the heat absorption plate HAP, and another anode terminal AE and another cathode terminal CE are also formed independently from each other on the outer surface of the heat absorption plate HAP so as to correspond to the anode terminal AE and the cathode terminal CE on the inner surface. Further, the anode terminal AE and the cathode terminal CE, which are independent from each other on the inner surface, are electrically connected to the other anode terminal AE and the other cathode terminal CE, which are independent from each other on the outer surface, through conventional electrically connecting members positioned in a plurality of through holes formed in the heat absorption plate HAP.

The anode terminal AE and the cathode terminal CE provide the plurality of terminals 15 for supplying electric current to the electronic cooling element 16.

FIG. 8 shows a plurality of metal bumps MB formed on each of the anode terminal AE and the cathode terminal CE on the outer surface of the heat absorption plate HAP. As described above, the metal bumps MB are preferably gold bumps, and may be preferably formed on the anode terminal AE and cathode terminal CE providing the plurality of terminals 15 of the electronic cooling element 16 and/or on the plurality of terminals 26 for the electronic cooling element 16 on the main body 18 of the base 20. Note that, since the heat resistance between the terminals 26 for the electronic cooling element 16 on the base 20 and the terminals 15 of the electronic cooling element 16 can be reduced by disposing the many metal bumps MB, heat can be effectively transferred therebetween.

The many metal bumps MB further electrically connect and mechanically fix the anode terminal AE and cathode terminal CE, which are disposed on the heat absorption surface 16a on the outer surface of the heat absorption plate HAP of the electronic cooling element 16 and which provide the terminals 15, to the terminals 26 (refer to FIG. 3) for the electronic cooling element 16 on the other of the above described two parallel regions of the longitudinal direction extending surface 18a of the main body 18 of the base 20.

The image pick-up module 10 for an endoscope apparatus, configured as described above, has a size of about 2 mm×about 2 mm when the image pick-up device 12 is viewed in the longitudinal direction LD, and a length of about 4 mm from an outer end of the image pick-up device 12 to the proximal end 18c of the main body 18 of the base 20.

The image pick-up module 10 for an endoscope apparatus is accommodated in a predetermined position of the distal end portion of the slender insertion part of the not shown endoscope apparatus described above. In this time, the image pick-up device 12 of the image pick-up module 10 is directed to the distal end of the insertion part and faces an infrared ray cut filter and an objective lens, both of which are not shown and which are disposed in the distal end portion of the insertion part.

When the image pick-up device 12 is operated through the external wirings 30 disposed in the slender insertion part of the not shown endoscope apparatus described above, the image pick-up device 12 can pick up an image of an observation target to which the not shown infrared ray cut filter and objective lens in the distal end portion of the slender insertion part of the not shown endoscope apparatus face. The image pick-up device 12 and the various electronic elements 14 providing the peripheral circuit for the image pick-up device 12 generate heat while they are in operation.

Since the main body 18 of the base 20 is as small as described above, the heat is promptly transferred to the terminals 26 for the electronic cooling element 16 through the main body 18 of the base 20, further promptly transferred to the anode terminal AE and cathode terminal CE of the terminals 15 of the electronic cooling element 16 because these terminals 15 are connected to the terminals 26 on the main body 18 of the base 20 through the many metal bumps MB having the good heat conductivity as described above, and further promptly transferred to the heat absorption plate HAP of the electronic cooling element 16 adjacent to the anode terminal AE and cathode terminal CE.

The electronic cooling element 16 promptly transfers the heat from the heat absorption plate HAP to the heat radiation plate HDP, and further the heat is radiated (transferred) promptly from the heat radiation plate HDP by the heat radiation sheet 32 (refer to FIGS. 1 and 2) or the refrigerant jacket 34 (refer to FIGS. 5 and 6) with the refrigerant circulation tubes 38. Finally, the heat radiation sheet 32 or the refrigerant jacket 34 with the refrigerant circulation tubes 38 radiates (transfers) the heat from the image pick-up module 10 in the distal end portion of the insertion part of the not shown endoscope apparatus to the proximal end portion thereof in the longitudinal direction LD of the insertion part.

In the image pick-up module 10 for an endoscope apparatus, configured as described above, the plurality of terminals 24a, 24b for the electronic elements 14 and image pick-up device 12 and the plurality of Terminals 26 for the electronic cooling element 16 are disposed on one of the two parallel regions of the slender square-shaped second end portion and on the region on the peripheral surface of the enlarged first end portion, the region being adjacent to the one region of the second end portion, in the longitudinal direction extending surface 18a of the main body 18 of the base 20. Further, the plurality of terminals 24a, i.e., the various electronic elements 14 connected thereto, are scattered on the one parallel region of the longitudinal direction extending surface 18a of the main body 18 along the longitudinal direction LD of the insertion part of the not shown endoscope apparatus. More further, the plurality of terminals 26, i.e., the plurality of terminals 15 of the heat absorption surface 16a of the electronic cooling element 16 which are connected thereto, are disposed on the other of the two parallel regions of the slender square-shaped second end portion in the longitudinal direction extending surface 18a of the main body 18 of the base 20 so that terminals 26, i.e. terminals 15 of the heat absorption surface 16a of the electronic cooling element 16, are enlarged along the longitudinal direction LD of the insertion part of the not shown endoscope apparatus.

These depositions makes a large amount of heat, which is generated from the various electronic elements 14 including the image pick-up device 12 when they are operated, being promptly diffused on the one parallel region of the longitudinal direction extending surface 18a along the longitudinal direction LD. Further, the diffused heat can be discharged (transferred) promptly by the electronic cooling element 16 from its heat radiation surface 16b, because the plurality of terminals 15 of the heat absorption surface 16a of the electronic cooling element 16 are mounted on the terminals 26, which are enlarged in the longitudinal direction LD, on the other parallel region of the longitudinal direction extending surface 18a through the many metal bumps MB.

The electronic cooling element 16, as well as the various electronic elements 14, can be easily mounted on the longitudinal direction extending surface 18a of the main body 18 of the base 20. In addition, the plurality of external wirings 30, which are necessary to control the electronic cooling element 16, can be easily drawn out from the plurality of terminals 28 at the position near to the second end of the main body 18 of the base 20 on the other of the two parallel regions of the longitudinal direction extending surface 18a of the main body 18, in place of being drawn out from the plurality of terminals 15 of the electronic cooling element 16. Also, the plurality of external wirings 30, which are necessary to control the image pick-up device 12 and various electronic elements 14, can be easily drawn out from the plurality of terminals 28 at the position near to the second end of the main body 18 of the base 20 on the one of the two parallel regions of the longitudinal direction extending surface 18a of the main body 18. Accordingly, the diameter of the image pick-up module 10 for an endoscope apparatus can be reduced.

The electronic cooling element 16 whose heat absorption surface 16a is enlarged along the longitudinal direction extending surface 18a can promptly absorb the heat from the longitudinal direction extending surface 18a of the main body 18 of the base 20, and widely diffuse the heat from the heat radiation surface 16b opposite to the heat absorption surface 16a, along the longitudinal direction LD. Further, the heat radiation sheet 32 (refer to FIGS. 1 and 2) or the refrigerant jacket 34 with the refrigerant circulation tubes 38 (refer to FIGS. 5 and 6) promotes heat transfer from the heat radiation surface 16b toward the proximal end of the slender insertion part of the not shown endoscope apparatus.

The various electronic elements 14 and the electronic cooling element 16, which are connected to the longitudinal direction extending surface 18a of the main body 18 of the base 20 through the plurality of terminals 24a and the plurality of terminals 26, do not largely project from the longitudinal direction extending surface 18a in the radial direction of the slender insertion part of the not shown endoscope apparatus.

On the longitudinal direction extending surface 18a of the main body 18 of the base 20, the plurality of terminals 28 for the external wirings are disposed closer to the second end 18c than the plurality of terminals 24b for the electronic elements 14 and the plurality of terminals 26 for the electronic cooling element 16. Accordingly, the plurality of external wirings 30 connected to the plurality of terminals 28 do not overlap the various electronic elements 14 and electronic cooling element 16 which are connected to the plurality of terminals 24a and the plurality of terminals 26, not only in the radial direction of the slender insertion part of the not shown endoscope apparatus but also in the longitudinal direction LD thereof. Thus, the plurality of external wirings 30 do not largely project from the longitudinal direction extending surface 18a in the radial direction of the slender insertion part of the not shown endoscope apparatus.

Further, the wiring 12a for the image pick-up device 12 extends from the image pick-up device 12 toward the plurality of terminals 24b on the longitudinal direction extending surface 18a of the main body 18 of the base 20 along the longitudinal direction extending surface 18a, and the heat radiation sheet 32 or the refrigerant circulation tubes 38 of the refrigerant jacket 34 extend from the heat radiation surface 16b of the electronic cooling element 16 along the longitudinal direction extending surface 18a and the longitudinal direction LD. Accordingly, the wiring 12a for the image pick-up device 12 and the heat radiation sheet 32 or the refrigerant circulation tubes 38 of the refrigerant jacket 34 do not largely project from the longitudinal direction extending surface 18a in the radial direction of the slender insertion part of the not shown endoscope apparatus.

Moreover, the various electronic elements 14 and the electronic cooling element 16, which are mounted on the two parallel regions, facing in the opposite directions, of the longitudinal direction extending surface 18a on the slender square-shaped second end portion through the plurality of terminals 24a and the plurality of terminals 26, reduce the length of the main body 18 of the base 20 in the longitudinal direction LD. That is, it is possible to reduce the overall size of the image pick-up module 10 for an endoscope apparatus 10 according to this embodiment of the present invention.

Further, the plurality of terminals 24b for the various electronic elements 14 are disposed on the one of the two parallel regions, facing in the opposite directions, of the slender square-shaped second end portion on the longitudinal direction extending surface 18a of the main body 18 of the base 20, and the plurality of terminals 24a for the image pick-up device 12 are disposed on the region, adjoining the above described one parallel region of the slender square-shaped second end portion, of the outer periphery of the enlarged first end portion. And, the plurality of terminals 26 for the electronic cooling element 16 is disposed on the other parallel region of the slender square-shaped second end portion. That is, since the image pick-up device 12 and the various electronic elements 14 are disposed adjacent to each other, the various electronic elements 14 are hard to be affected by electric noise.

### Another Embodiment

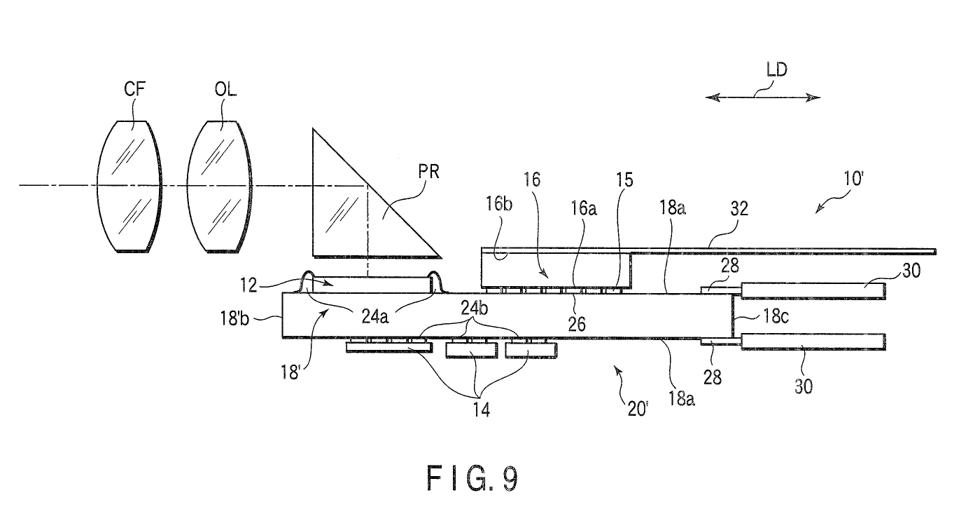

Next, with reference to FIG. 9, an image pick-up module 10′ for an endoscope apparatus, according to another embodiment of the present invention will be described.

Almost all of the structure of the image pick-up module 10′ for an endoscope apparatus is the same as almost all the structure of the image pick-up module 10 for an endoscope apparatus according to the above described embodiment of the present invention with reference to FIGS. 1 to 8. Accordingly, in the image pick-up module 10′, the same components as those of the image pick-up module 10 according to the above described embodiment of the present invention are denoted by the same reference numerals as those denoting the corresponding components of the image pickup module 10 described above, and the detailed explanations thereof are omitted.

The image pick-up module 10′ is different from the image pick-up module 10 in that the whole main body 18′ of a base 20′ has a slender, flat, and rectangular shape, and the longitudinal cross section of the main body 18′ in a direction along the longitudinal direction LD of the slender insertion part of the not shown endoscope apparatus is an I-shape.

The image pick-up device 12 is not disposed on a first end 18′b of the main body 18′ but, together with the electronic cooling element 16, on one of two flat regions of the longitudinal direction extending surface 18a so as to be located in a side of the first end 18′b with respect to the electronic cooling element 16 and to be adjacent to the electronic cooling element 16. An image pick-up surface of the image pick-up device 12 directs in a direction intersecting the longitudinal direction LD, i.e., the radial direction of the insertion part in this embodiment.

A prism PR is disposed in the distal end portion of the insertion part of the not shown endoscope apparatus, in which the image pick-up module 10′ is accommodated, so as to face the image pick-up device 12 of the image pick-up module 10′ disposed at a predetermined position of the distal end portion. Further, an infrared ray cut filter CF and an objective lens OL are disposed in the distal end portion of the insertion part to face the image pick-up device 12 through the prism PR.

In this image pick-up module 10′, the longitudinal cross section of the main body 18′ of the base 20′ has the I-shape, and the image pick-up device 12 is not disposed on the first end 18′b of the main body 18′ but disposed on the one of two flat regions of the longitudinal direction extending surface 18a. Accordingly, the size of the image pick-up module 10′ in the radial direction of the slender insertion part of the not shown endoscope apparatus is very smaller than the size of the image pick-up module 10 according to the above described one embodiment in the radial direction because, in the image pick-up module 10, the image pick-up device 12 is disposed on the first end 18b of the enlarged first end portion of the main body 18 of the base 20 and the longitudinal cross section of the main body 18 is the approximately T-shape.

Moreover, the image pick-up device 12 is not disposed on the first end 18′b of the main body 18′ but, together with the electronic cooling element 16, disposed on the one flat region of the longitudinal direction extending surface 18a so as to be located in a side of the first end 18′b of the main body 18′ with respect to the electronic cooling element 16 and to be adjacent the electronic cooling element 16. Accordingly, heat generated from the image pick-up device 12 during the operation of the image pick-up device 12 is promptly transferred to the electronic cooling element 16 adjacent to the image pick-up device 12 through the main body 18′ and the not shown internal wirings described above, and promptly absorbed by the heat absorption surface 16a of the electronic cooling element 16.

Although the image pick-up device 12 is disposed on one of the two flat regions, which direct oppositely in the radial direction of the slender insertion part of the not shown endoscope apparatus, of the longitudinal direction extending surface 18a of the main body 18′ of the base 20′, and the various electronic elements 14 for the image pick-up device 12 are disposed on the other flat region, the thickness of the main body 18′ between the two flat regions is thin. Accordingly, although the image pick-up device 12 and the various electronic elements 14 for the image pick-up device 12 are disposed across the main body 18′, they are closely disposed to each other. Moreover, since the plurality of terminals 24a for the image pick-up device 12 are connected to the terminals 24b for the various electronic elements 14 by the not shown internal wirings of the thin main body 18, the various electronic elements 14 are hard to be affected by electric noise.

Further, the electronic cooling element 16 is disposed on one of the two flat regions, which direct oppositely in the radial direction of the slender insertion part of the not shown endoscope apparatus, of the longitudinal direction extending surface 18a of the main body 18′ of the base 20′ so as to be adjacent the image pick-up device 12, and the various electronic elements 14 for the image pick-up device 12 are disposed on the other flat region so as to correspond to the image pick-up device 12. Then, the plurality of terminals 24b for the various electronic elements 14 are connected to the plurality of terminals 26 for the electronic cooling element 16 by the not shown internal wirings of the thin main body 18′. Accordingly, heat generated from the various electronic elements 14 during the operation thereof is promptly transferred to the electronic cooling element 16 through the thin main body 18′ and the internal wirings described above, and promptly absorbed by the heat absorption surface 16a of the electronic cooling element 16.

Note that in the image pick-up module 10 according to each of the one embodiment and the modification thereof and described with reference to FIGS. 1 to 8 and in the image pick-up module 10′ according to the another embodiment and described above with reference to FIG. 9, the longitudinal direction extending surface 18a of the main body 18 of the base 20 or the main body 18′ of the base 20′ has the two parallel regions which direct oppositely in the radial direction orthogonal to the longitudinal direction LD of the insertion part of the not shown endoscope apparatus. And, at least a part of the plurality of terminals 24a, 24b for the image pick-up device 12 and various electronic elements 14 is disposed to one of the two parallel regions, and the plurality of terminals 26 for the electronic cooling element 16 are disposed on the other region.

However, the longitudinal direction extending surface of the main body of the base can have two regions which only direct in two directions being different from each other in the above described radial direction, at least the part of the plurality of terminals 24a, 24b can be disposed on one of the two regions, and the plurality of terminals 26 can be disposed to the other region.

The main body having the longitudinal direction extending surface having such two regions as described can be a triangle shape or a polygonal shape including a pentagonal shape or more multi-angled shape in its cross section orthogonal to the longitudinal direction LD.

Note that, also in the another embodiment of the present invention described above with reference to FIG. 9, the terminals 15 of the heat absorption surface 16a of the electronic cooling element 16 can be mounted on the plurality of terminals 26 for the electronic cooling element 16 on the base 20′ through many metal bumps MB (refer to FIG. 8), like in the embodiment and modification of the present invention described above with reference to FIGS. 1 to 8. In this case, the large amount of heat, which is generated from the various electronic elements 14 including the image pick-up device 12 and which is promptly transferred to the plurality of terminals 26 for the electronic cooling element 16 on the base 20′ through the thin main body 18′ of the base 20′ and through the not shown internal wirings described above, can be promptly absorbed to the heat absorption surface 16a of the electronic cooling element 16 through the many metal bumps MB (refer to FIG. 8) and thus can be promptly radiated from the heat radiation surface 16b of the electronic cooling element 16. Then, the various electronic elements 14 including the image pick-up device 12 can be effectively cooled.

The electronic cooling element 16 can be easily mounted on the base 20′ likewise the image pick-up device 12 and the various electronic elements 14. Further, the plurality of external wirings 30 for controlling the electronic cooling element 16, are not directly drawn out from the electronic cooling element 16 but drawn out from the plurality of terminals 28 of the base 20′, and also the plurality of external wirings 30 for controlling the image pick-up device 12 and the various electronic elements 14 are drawn out from the plurality of terminals 28 of the base 20′. Accordingly, the plurality of the external wirings 30 can be easily gathered and drawn out, and the reduction of the diameter of the image pick-up module 101 is not inhibited

Additional advantages and modifications will readily occur to those skilled in the art. Therefore, the invention in its broader aspects is not limited to the specific details and representative embodiments shown and described herein. Accordingly, various modifications may be made without depending from the spirit or scope of the general inventive concept as defined by the appended claims and their equivalents.

What is claimed is:

1. An image pick-up module for an endoscope apparatus, accommodated in an insertion part of the endoscope apparatus to pick up an image of an observation target, comprising:
electronic elements including an image pick-up device;
an electronic cooling element which includes a heat absorption surface, a heat radiation surface, and a plurality of terminals disposed on the heat absorption surface; and
a base having a surface on which the electronic elements including the image pick-up device and the electronic cooling element are mounted, the surface of the base being provided with a plurality of terminals for electrically connecting with the electronic elements including the image pick-up device, a plurality of terminals for electrically connecting with the plurality of terminals of the electronic cooling element, and a plurality of terminals for electrically connecting with a plurality of wirings from an outside of the image pick-up module, and the base having wirings which electrically connect with the terminals for the electronic elements including the image pick-up device, the terminals for the electronic cooling element, and the terminals for the outside wirings.

2. The image pick-up module for an endoscope apparatus according to claim 1, wherein the plurality of wirings from the outside include a plurality of wirings for controlling the electronic devices including the image pick-up device and a plurality of wirings for controlling the electronic cooling element.

3. The image pick-up module for an endoscope apparatus according to claim 2, wherein the plurality of terminals of the electronic cooling element are mechanically connected to the plurality of terminals for the electronic cooling element on the base through a plurality of electrically conductive joint members having a good thermal conductivity.

4. The image pick-up module for an endoscope apparatus according to claim 3, wherein the joint member is a metal bump, and a plurality of metal bumps are formed on at least one of the plurality of terminals of the electronic cooling element and the plurality of terminals for the electronic cooling element on the base.

5. The image pick-up module for an endoscope apparatus according to claim 4, wherein a region of the surface of the base, on which the electronic cooling element is mounted, extends in a longitudinal direction of the insertion part of the endoscope apparatus.

6. The image pick-up module for an endoscope apparatus according to claim 4, wherein a region of the surface of the base, on which the image pick-up device is mounted, extends in a direction orthogonal to a longitudinal direction of the insertion part of the endoscope apparatus.

7. The image pick-up module for an endoscope apparatus according to claim 4, wherein a heat radiation sheet having flexibility is attached to the heat radiation surface of the electronic cooling element, and the heat radiation sheet extends in a longitudinal direction of the insertion part of the endoscope apparatus.

8. The image pick-up module for an endoscope apparatus according to claim 4, wherein a refrigerant jacket having a plurality of refrigerant circulation tubes is attached to the heat radiation surface of the electronic cooling element, and the plurality of refrigerant circulation tubes extend from the refrigerant jacket in a longitudinal direction of the insertion part of the endoscope apparatus.

9. The image pick-up module for an endoscope apparatus according to claim 1, wherein the plurality of terminals of the electronic cooling element are mechanically connected to the plurality of terminals for the electronic cooling element on the base through a plurality of electrically conductive joint members having a good thermal conductivity.

10. The image pick-up module for an endoscope apparatus according to claim 9, wherein the joint member is a metal bump, and a plurality of metal bumps are formed on at least one of the plurality of terminals of the electronic cooling element and the plurality of terminals for the electronic cooling element on the base.

11. The image pick-up module for an endoscope apparatus according to claim 10, wherein a region of the surface of the base, on which the electronic cooling element is mounted, extends in a longitudinal direction of the insertion part of the endoscope apparatus.

12. The image pick-up module for an endoscope apparatus according to claim 10, wherein a region of the surface of the base, on which the image pick-up device is mounted, extends in a direction orthogonal to a longitudinal direction of the insertion part of the endoscope apparatus.

13. The image pick-up module for an endoscope apparatus according to claim 10, wherein a heat radiation sheet having flexibility is attached to the heat radiation surface of the electronic cooling element, and the heat radiation sheet extends in a longitudinal direction of the insertion part of the endoscope apparatus.

14. The image pick-up module for an endoscope apparatus according to claim 10, wherein a refrigerant jacket having a plurality of refrigerant circulation tubes is attached to the heat radiation surface of the electronic cooling elements and the plurality of refrigerant circulation tubes extend from the refrigerant jacket in a longitudinal direction of the insertion part of the endoscope apparatus.

15. The image pick-up module for an endoscope apparatus according to claim 1, wherein a region of the surface of the base, on which the electronic cooling element is mounted, extends in a longitudinal direction of the insertion part of the endoscope apparatus.

16. The image pick-up module for an endoscope apparatus according to claim 1, wherein a region of the surface of the base, on which the image pick-up device is mounted, extends in a direction orthogonal to a longitudinal direction of the insertion part of the endoscope apparatus.

17. The image pick-up module for an endoscope apparatus according to claim 1, wherein a heat radiation sheet having flexibility is attached to the heat radiation surface of the electronic cooling element, and the heat radiation sheet extends in a longitudinal direction of the insertion part of the endoscope apparatus.

18. The image pick-up module for an endoscope apparatus according to claim 1, wherein a refrigerant jacket having a plurality of refrigerant circulation tubes is attached to the heat radiation surface of the electronic cooling element, and the plurality of refrigerant circulation tubes extend from the refrigerant jacket in a longitudinal direction of the insertion part of the endoscope apparatus.
